(19) United States
(12) Patent Application Publication
(10) Pub. No.: US 2012/0328956 A1
(43) Pub. Date: Dec. 27, 2012

(54) MULTILAYER GRAPHENE AND POWER STORAGE DEVICE

(75) Inventors: Teppei OGUNI, Atsugi (JP); Hiroatsu TODORIKI, Atsugi (JP); Takeshi OSADA, Isehara (JP)

(73) Assignee: SEMICONDUCTOR ENERGY LABORATORY CO., LTD., Atsugi-shi (JP)

(21) Appl. No.: 13/526,709

(22) Filed: Jun. 19, 2012

(30) Foreign Application Priority Data
Jun. 24, 2011 (JP) 2011-141036

(51) Int. Cl. B32B 5/00; H01M 4/62; B82Y 30/00

(52) U.S. Cl. 429/232; 428/221; 977/734; 977/948

(57) ABSTRACT

To provide graphene through which ions can transfer in the direction perpendicular to a plane of the graphene. Multilayer graphene includes a plurality of graphenes stacked in a layered manner. The plurality of graphenes contain a six-membered ring composed of carbon atoms, a poly-membered ring which is a seven or more-membered ring composed of carbon atoms or carbon atoms and one or more oxygen atoms, and an oxygen atom bonded to one of the carbon atoms in the six-membered ring and the poly-membered ring, which is a seven or more-membered ring. The interlayer distance between adjacent graphenes of the plurality of graphenes is greater than 0.34 nm and less than or equal to 0.5 nm, preferably greater than or equal to 0.38 nm and less than or equal to 0.42 nm.

### BACKGROUND OF THE INVENTION

1. Field of the Invention

The present invention relates to multilayer graphene, a power storage device containing the multilayer graphene, and a semiconductor device containing the multilayer graphene.

2. Description of the Related Art

In recent years, the use of graphene as a conductive electronic material in semiconductor devices has been studied. Graphene is a lateral layer in graphite, i.e., a carbon layer in which six-membered rings each composed of carbon atoms are connected in the planar direction, and a stack of two or more and 100 or less carbon layers is referred to as multilayer graphene.

Graphene is chemically stable and has favorable electric characteristics and thus has been expected to be applied to channel regions of transistors, vias, wirings, and the like included in semiconductor devices.

On the other hand, an active electrode material is coated with graphene in order to increase the conductivity of a material of an electrode of a lithium-ion battery (see Patent Document 1).

### REFERENCE

[Patent Document 1] Japanese Published Patent Application No. 2011-029184

### SUMMARY OF THE INVENTION

Graphene has high conductivity because six-membered rings each composed of carbon atoms are connected in the planar direction. That is, graphene has high conductivity in the planar direction. Graphene has a sheet shape and a gap is provided between stacked graphenes, so that ions can transfer in the region. However, the transfer of ions in the direction perpendicular to the graphene is difficult.

An electrode included in a power storage device includes a current collector and an active material layer. In the case of a conventional electrode, an active material layer includes a conductive additive, binder, and the like as well as an active material, and the discharge capacity per unit weight of the active material layer is reduced due to the conductive additive, the binder, and the like. Further, the binder included in the active material layer swells as it comes into contact with an electrolyte, so that the electrode is likely to be deformed and broken.

In view of the above problems, an object of one embodiment of the present invention is to provide graphene through which ions can transfer in the direction perpendicular to a plane of the graphene. Another object is to provide a power storage device having a higher discharge capacity and favorable electric characteristics. Another object is to provide a power storage device having high reliability and high durability.

One embodiment of the present invention is multilayer graphene including a plurality of graphenes stacked in a layered manner. The plurality of graphenes contain a six-membered ring composed of carbon atoms, a poly-membered ring which is a seven or more-membered ring composed of carbon atoms, and an oxygen atom bonded to one of the carbon atoms in the six-membered ring and the poly-membered ring, which is a seven or more-membered ring. The interlayer distance between adjacent graphenes of the plurality of graphenes is greater than 0.34 nm and less than or equal to 0.5 nm, preferably greater than or equal to 0.38 nm and less than or equal to 0.42 nm.

One embodiment of the present invention is multilayer graphene including a plurality of graphenes stacked in a layered manner. The plurality of graphenes contain a six-membered ring composed of carbon atoms, and a poly-membered ring which is a seven or more-membered ring composed of carbon atoms and one or more oxygen atoms. The interlayer distance between adjacent graphenes of the plurality of graphenes is greater than 0.34 nm and less than or equal to 0.5 nm, preferably greater than or equal to 0.38 nm and less than or equal to 0.42 nm.

According to one embodiment of the present invention, carbon layers are stacked in a layered manner. In the carbon layers, a plurality of six-membered rings each composed of carbon atoms and a plurality of poly-membered rings which are seven or more-membered rings each composed of carbon atoms are connected in the planar direction, and an oxygen atom is bonded to one of the carbon atoms in the six-membered ring and the poly-membered ring, which is a seven or more-membered ring. The interlayer distance between the carbon layers is greater than 0.34 nm and less than or equal to 0.5 nm.

According to one embodiment of the present invention, carbon layers are stacked in a layered manner. In the carbon layers, a plurality of six-membered rings each composed of carbon atoms and a plurality of poly-membered rings which are seven or more-membered rings each composed of carbon atoms and one or more oxygen atoms are connected in the planar direction. The interlayer distance between the carbon layers is greater than 0.34 nm and less than or equal to 0.5 nm.

Note that an oxygen atom may be bonded to one of the carbon atoms in the six-membered ring and the poly-membered ring, which is a seven or more-membered ring.

Graphene refers to one atomic layer of a sheet of carbon molecules having double bonds (also referred to as graphite bonds or sp² bonds). Further, graphene is flexible. The planar shape of graphene is a given shape such as a rectangular shape or a circular shape.

The multilayer graphene includes two or more and 100 or less graphene layers. The graphene layers are stacked in parallel with a surface of a substrate. The concentration of oxygen contained in the multilayer graphene is 3 at. % to 10 at. % inclusive.

In the graphene, the poly-membered ring is formed when a carbon-carbon bond in part of the six-membered ring is broken. Alternatively, the poly-membered ring is formed when a carbon-carbon bond in part of the six-membered ring is broken and an oxygen atom is bonded to the carbon atoms in the six-membered ring. The poly-membered ring serves as an opening in the graphene which allows the transfer of ions. The distance between adjacent graphenes in the multilayer graphene is greater than 0.34 nm and less than or equal to 0.5 nm, while the interlayer distances between graphenes composing normal graphite are each about 0.34 nm. Therefore, the transfer of ions between graphenes is easier in the multilayer graphene than in graphite.

According to one embodiment of the present invention, a positive electrode active material layer included in a positive electrode of a power storage device contains a positive electrode active material and multilayer graphene at least partly surrounding the positive electrode active material. Further, according to one embodiment of the present invention, a negative electrode active material layer included in a negative electrode of a power storage device contains a negative electrode active material and multilayer graphene at least partly surrounding the negative electrode active material.

The multilayer graphene has a sheet-like or net-like shape. Here, the net-like shape includes a two-dimensional shape and a three-dimensional shape in its category. A plurality of the positive electrode active materials or a plurality of the negative electrode active materials are at least partly surrounded with one multilayer graphene or plural multilayer graphenes. Note that the multilayer graphene has a bag-like shape, and the plurality of positive electrode active materials or the plurality of negative electrode active materials are at least partly surrounded with the bag-like portion in some cases. The multilayer graphene partly has openings where the positive electrode active materials or the negative electrode active materials are exposed in some cases. The multilayer graphene can prevent dispersion of the positive electrode active materials or the negative electrode active materials and the collapse of the positive electrode active material layer or the negative electrode active material layer. Thus, the multilayer graphene has a function of maintaining the bond between the positive electrode active materials or the negative electrode active materials even when the volume of the positive electrode active materials or the negative electrode active materials is increased and decreased by charging and discharging.

In the positive electrode active material layer or the negative electrode active material layer, the plurality of positive electrode active materials or the plurality of negative electrode active materials are in contact with the multilayer graphene, so that electrons can transfer through the multilayer graphene. In other words, the multilayer graphene has a function of a conductive additive.

Thus, the positive electrode active material layer and the negative electrode active material layer contain multilayer graphenes, whereby the amounts of binder and conductive additives which are contained in the positive electrode active material layer and the negative electrode active material layer can be reduced; accordingly, the amount of active materials contained in the positive electrode active material layer and the negative electrode active material layer can be increased. Further, the reduction in amount of the binder leads to an increase in durability of the positive electrode active material layer and the negative electrode active material layer.

According to one embodiment of the present invention, a surface of an uneven active material in a positive electrode or a negative electrode of a power storage device is coated with multilayer graphene. As well as covering the uneven surface, the multilayer graphene can prevent the collapse of the uneven positive electrode or negative electrode owing to its flexibility.

According to one embodiment of the present invention, more ions can transfer in the direction parallel to a surface of graphene and in the direction perpendicular to the surface of the graphene. The use of the multilayer graphene for a positive electrode or a negative electrode of a power storage device makes it possible to increase the amounts of active materials in a positive electrode active material layer and a negative electrode active material layer, leading to an increase in discharge capacity of the power storage device. Further, the use of the multilayer graphene, instead of binder, for a positive electrode or a negative electrode can increase the reliability and durability of the power storage device.

### BRIEF DESCRIPTION OF THE DRAWINGS

In the accompanying drawings:

FIGS. 1A to 1C illustrate multilayer graphene;

FIGS. 2A to 2D illustrate a negative electrode;

FIGS. 3A to 3C illustrate a positive electrode;

FIG. 4 illustrates a power storage device;

FIG. 5 is a plane SEM image of a negative electrode;

FIG. 6 is a cross-sectional TEM image of a negative electrode;

FIGS. 7A and 7B are cross-sectional TEM images of a negative electrode; and

FIG. 8 illustrates electric appliances.

### DETAILED DESCRIPTION OF THE INVENTION

Hereinafter, embodiments and examples will be described with reference to drawings. However, the embodiments and examples can be implemented in various modes. It will be readily appreciated by those skilled in the art that the modes and details can be changed in various ways without departing from the spirit and scope of the present invention. Therefore, the present invention should not be construed as being limited to the following descriptions of the embodiments and examples.

### Embodiment 1

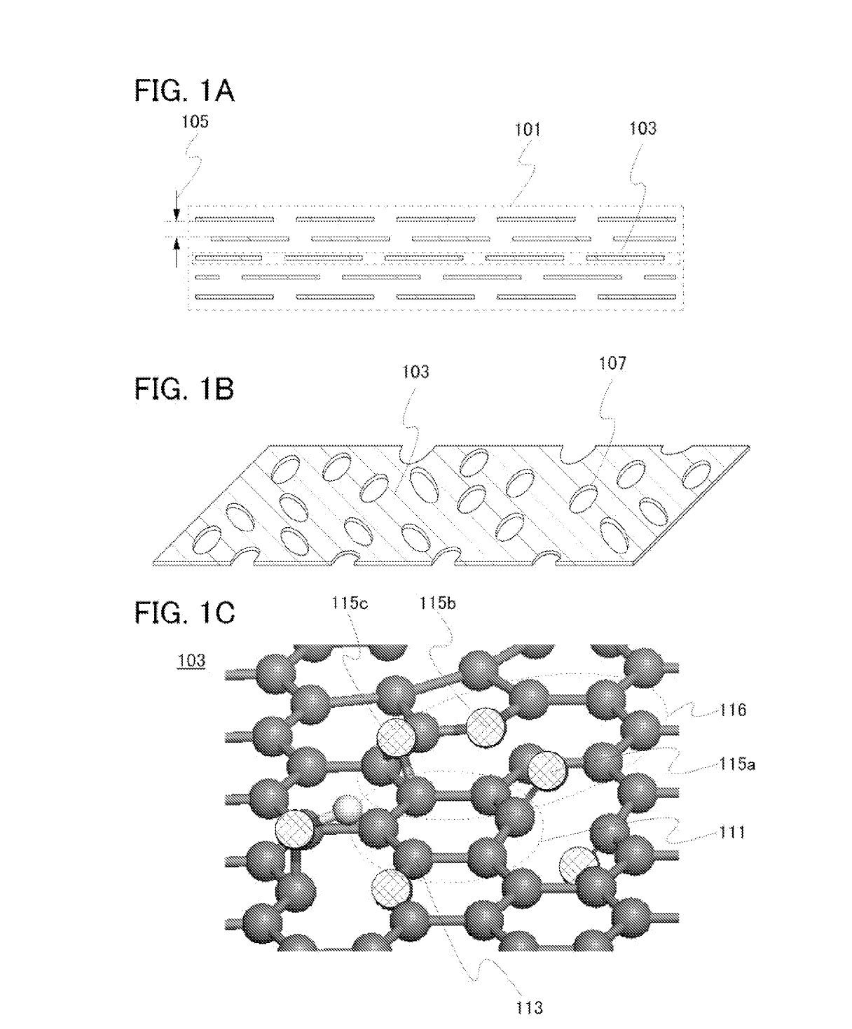

In this embodiment, a structure of multilayer graphene and a formation method thereof will be described with reference to FIGS. 1A to 1C.

FIG. 1A is a cross-sectional schematic view of multilayer graphene 101. In the multilayer graphene 101, a plurality of graphenes 103 overlap with each other in parallel or in substantially parallel. An interlayer distance 105 between the graphenes in this case is greater than 0.34 nm and less than or equal to 0.5 nm, preferably greater than or equal to 0.38 nm and less than or equal to 0.42 nm, more preferably greater than or equal to 0.39 nm and less than or equal to 0.41 nm. The multilayer graphene 101 includes two or more and 100 or less layers of the grahenes 103.

FIG. 1B is a perspective view of the graphene 103 in FIG. 1A. The graphene 103 has a sheet-like shape several μm on a side and includes openings 107. The openings 107 serve as paths which allow the transfer of ions. Thus, in the multilayer graphene 101 in FIG. 1A, ions can transfer in the direction parallel to a surface of the graphene 103, i.e., between the graphenes 103, and in the direction perpendicular to a surface of the multilayer graphene 101, i.e., through the openings 107 formed in the graphenes 103.

FIG. 1C is a schematic view illustrating examples of atomic arrangements in the graphene 103 in FIG. 1B. The graphene 103 contains six-membered rings 111 each composed of carbon atoms 113, which are connected in the planar direction, and poly-membered rings each formed when a carbon-carbon bond in part of a six-membered ring is broken, such as a seven-membered ring, an eight-membered ring, a nine-membered ring, and a ten-membered ring. The poly-membered ring corresponds to the opening 107 in FIG. 1B, and a region where the six-membered rings 111 each composed of the carbon atoms 113 are connected corresponds to a hatched region in FIG. 1B.

Some of the poly-membered rings are composed of only the carbon atoms 113. Such a poly-membered ring is formed when a carbon-carbon bond in part of a six-membered ring is broken. Further, an oxygen atom is bonded to one of the carbon atoms 113 in some of the other poly-membered rings composed of the carbon atoms 113. The above poly-membered ring is formed when a carbon-carbon bond in part of a six-membered ring is broken and an oxygen atom 115a is bonded to one of the carbon atoms in the six-membered ring. The poly-membered rings also include a poly-membered ring 116 composed of the carbon atoms 113 and an oxygen atom 115b. Furthermore, an oxygen atom 115c is bonded to one of the carbon atoms 113 in the poly-membered ring 116 composed of the carbon atoms 113 and the oxygen atom 115b or in the six-membered ring 111 composed of the carbon atoms 113.

The concentration of oxygen in the multilayer graphene 101 is 2 at. % to 11 at. % inclusive, preferably 3 at. % to 10 at. % inclusive. As the proportion of oxygen is lower, the conductivity of multilayer graphene in a direction parallel to the surface of the graphene can be higher. As the proportion of oxygen is higher, more openings serving as paths of ions in a direction perpendicular to the surface of the graphene can be formed.

The interlayer distances between graphenes composing normal graphite are each about 0.34 nm and do not vary significantly. On the other hand, in the multilayer graphene 101 described in this embodiment, one or more oxygen atoms are included in part of six-membered ring composed of carbon atoms. Alternatively, the multilayer graphene 101 contains a poly-membered ring which is a seven or more-membered ring composed of carbon atoms or carbon atoms and one or more oxygen atoms. Still alternatively, in the multilayer graphene 101, an oxygen atom is bonded to a carbon atom in a poly-membered ring which is a seven or more-membered ring. That is to say, the multilayer graphene 101 contains oxygen; thus, the interlayer distance between graphenes in the multilayer graphene 101 is longer than the interlayer distance of graphite. The longer interlayer distance facilitates the transfer of ions in the direction parallel to the surface of the graphene, between the graphene layers. In addition, openings formed in the graphene permit ions to easily transfer in the direction perpendicular to the surface of the graphene.

Next, a method for forming multilayer graphene will be described below.

First, a mixed solution containing graphene oxide is formed.

In this embodiment, graphene oxide is formed by an oxidation method called a Hummers method. A Hummers method is as follows: a sulfuric acid solution of potassium permanganate is mixed into graphite powder to cause oxidation reaction; thus, a mixed solution containing graphite oxide is formed. Graphite oxide contains a functional group such as a carbonyl group, a carboxyl group, or a hydroxyl group due to oxidation of carbon in graphite. Accordingly, the interlayer distance between adjacent graphenes of a plurality of graphenes in graphite oxide is longer than the interlayer distance of graphite. Then, ultrasonic vibration is transferred to the mixed solution containing graphite oxide, so that the graphite oxide whose interlayer distance is long can be cleaved to give graphene oxide. Note that commercial graphene oxide may be used.

In a liquid having polarity, different multilayer graphenes are not easily aggregated because oxygen contained in the multilayer graphenes is negatively charged.

Next, the mixed solution containing graphene oxide is applied to a substrate. As a method of applying the mixed solution containing graphene oxide to the substrate, a coating method, a spin coating method, a dipping method, a spray method, an electrophoresis method, or the like may be employed. Alternatively, these methods may be combined as appropriate to be employed. For example, after the mixed solution containing graphene oxide is applied to a substrate by a dipping method, the substrate is rotated as in a spin coating method, so that the evenness of the thickness of the mixed solution containing graphene oxide can be improved.

Then, part of oxygen is released from the graphene oxide provided over the substrate by reduction treatment. In the reduction treatment, heating is performed at higher than or equal to 150° C., preferably higher than or equal to 200° C. in a vacuum, in a reducing atmosphere such as an inert gas (nitrogen, a rare gas, or the like) atmosphere, or in the air. By being heated at a higher temperature and for a longer time, graphene oxide is reduced to a higher extent so that multilayer graphene with high purity (i.e., with a low concentration of elements other than carbon) can be obtained.

Since graphite is treated with sulfuric acid according to the Hummers method, a sulfone group and the like are also bonded to graphene oxide, and its decomposition (release) is caused at 200° C. to 300° C. inclusive, preferably 200° C. to 250° C. inclusive. Therefore, graphene oxide is preferably reduced at higher than or equal to 200° C.

Through the reduction treatment, adjacent graphenes are bonded to each other to form a huge net-like or sheet-like shape. Further, through the reduction treatment, openings are formed in the graphenes due to the release of oxygen. Furthermore, the graphenes overlap with each other in parallel to a surface of the substrate. Thus, multilayer graphene through which ions can transfer is formed.

Through the above process, highly conductive multilayer graphene through which ions can transfer in the direction parallel to a surface thereof and in the direction perpendicular to the surface thereof can be formed.

### Embodiment 2

In this embodiment, a structure of an electrode of a power storage device and a formation method of the electrode will be described.

First, a negative electrode and a formation method thereof will be described.

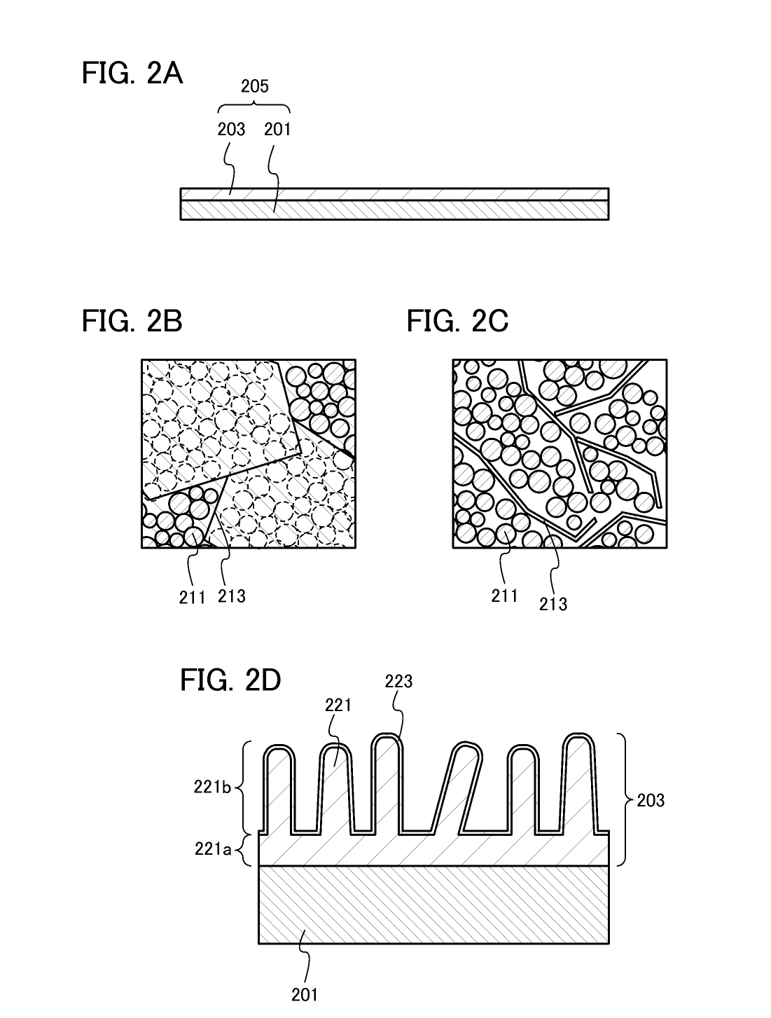

FIG. 2A is a cross-sectional view of a negative electrode 205. In the negative electrode 205, a negative electrode active material layer 203 is formed over a negative electrode current collector 201.

Note that an active material refers to a material that relates to intercalation and deintercalation of ions serving as carriers. Thus, the active material and the active material layer are distinguished.

As the negative electrode current collector 201, a material having high conductivity such as copper, stainless steel, iron, or nickel can be used. The negative electrode current collector 201 can have a foil shape, a plate shape, a film shape, or the like as appropriate.

The negative electrode active material layer 203 is formed using a negative electrode active material which can occlude and release ions serving as carriers. As typical examples of the negative electrode active material, lithium, aluminum, graphite, silicon, tin, and germanium are given. Further, a compound containing one or more of lithium, aluminum, graphite, silicon, tin, and germanium is given. Note that it is possible to omit the negative electrode current collector 201 and use the negative electrode active material layer 203 alone for a negative electrode. The theoretical ion metal occlusion capacity is higher in germanium, silicon, lithium, and aluminum as a negative electrode active material than in graphite as a negative electrode active material. When the occlusion capacity is high, charge and discharge can be performed sufficiently even in a small area, so that reductions in cost and size of a metal-ion secondary battery typified by a lithium-ion secondary battery can be achieved.

As examples of carrier ions used for metal-ion secondary batteries other than lithium-ion secondary batteries, alkali-metal ions such as sodium ions and potassium ions; alkaline-earth metal ions such as calcium ions, strontium ions, and barium ions; beryllium ions; magnesium ions; and the like are given.

FIG. 2B is a plan view of the negative electrode active material layer 203. The negative electrode active material layer 203 contains negative electrode active materials 211 which are particles capable of occluding and releasing carrier ions, and multilayer graphenes 213 which cover a plurality of particles of the negative electrode active materials 211 and at least partly surround the plurality of particles of the negative electrode active materials 211. The different multilayer graphenes 213 cover surfaces of the plurality of particles of the negative electrode active materials 211. The negative electrode active materials 211 may partly be exposed.

FIG. 2C is a cross-sectional view of part of the negative electrode active material layer 203 in FIG. 2B. The negative electrode active material layer 203 contains the negative electrode active materials 211 and the multilayer graphenes 213 at least partly surrounding the negative electrode materials 211. The multilayer graphenes 213 are observed to have linear shapes in cross section. A plurality of particles of the negative electrode active materials are at least partly surrounded with one multilayer graphene or plural multilayer graphenes. Note that the multilayer graphene has a bag-like shape, and the plurality particles of the negative electrode active materials is at least partly surrounded with the bag-like portion in some cases. The multilayer graphene partly has openings where the negative electrode active materials are exposed in some cases.

The desired thickness of the negative electrode active material layer 203 is determined in the range of 20 μm to 100 μm.

Note that the negative electrode active material layer 203 may contain acetylene black particles having a volume 0.1 to 10 times as large as that of the multilayer graphene, carbon particles having a one-dimensional expansion (e.g., carbon nanofibers), or other known binders.

The negative electrode active material layer 203 may be predoped with lithium. A lithium layer is formed on a surface of the negative electrode active material layer 203 by a sputtering method, whereby the negative electrode active material layer 203 can be predoped with lithium. Alternatively, lithium foil is provided on the surface of the negative electrode active material layer 203, whereby the negative electrode active material layer 203 can be predoped with lithium.

As an example of the negative electrode active material, a material whose volume is expanded by occlusion of ions serving as carriers is given. When such a material is used, the negative electrode active material layer gets vulnerable and is partly collapsed by charging and discharging, resulting in lower reliability of a power storage device. However, the multilayer graphene 213 covering the periphery of the negative electrode active materials 221 allows prevention of dispersion of the negative electrode active materials and the collapse of the negative electrode active material layer, even when the volume of the negative electrode active materials is increased and decreased due to charging and discharging. That is to say, the multilayer graphene has a function of maintaining the bond between the negative electrode active materials even when the volume of the negative electrode active materials is increased and decreased by charging and discharging.

The multilayer graphene 213 is in contact with a plurality of particles of the negative electrode active materials and serves also as a conductive additive. Further, the multilayer graphene 213 has a function of holding the negative electrode active materials capable of occluding and releasing carrier ions. Thus, binder does not necessarily have to be mixed into the negative electrode active material layer. Accordingly, the proportion of the negative electrode active materials in the negative electrode active material layer can be increased, which allows an increase in discharge capacity of a power storage device.

Next, a formation method of the negative electrode active material layer 203 in FIGS. 2B and 2C will be described.

Slurry containing negative electrode active materials which are particles and graphene oxide is formed. After a negative electrode current collector is coated with the slurry, heating is performed in a reducing atmosphere for reduction treatment so that the negative electrode active materials are baked and part of oxygen is released from the graphene oxide to form openings in graphene, as in the formation method of multilayer graphene, which is described in Embodiment 1. Note that oxygen in the graphene oxide is not entirely reduced and partly remains in the graphene. Through the above process, the negative electrode active material layer 203 can be formed over the negative electrode current collector 201.

Next, a structure of a negative electrode in FIG. 2D will be described.

FIG. 2D is a cross-sectional view of the negative electrode where the negative electrode active material layer 203 is formed over the negative electrode current collector 201. The negative electrode active material layer 203 contains a negative electrode active material 221 having an uneven surface and multilayer graphene 223 covering a surface of the negative electrode active material 221.

The uneven negative electrode active material 221 includes a common portion 221a and a projected portion 221b extending from the common portion 221a. The projected portion 221b can have a columnar shape such as a cylinder shape or a prism shape, or a needle shape such as a cone shape or a pyramid shape as appropriate. The top of the projected portion may be curved. The negative electrode active material 221 is formed using a negative electrode active material capable of occluding and releasing ions serving as carriers, typically, lithium ions, similarly to the negative electrode active material 211. Note that the common portion 221a and the projected portion 221b may be formed using either the same material or different materials.

In the case of silicon which is an example of a negative electrode active material, the volume is approximately quadrupled due to occlusion of ions serving as carriers; therefore, the negative electrode active material 221 gets vulnerable and is partly collapsed by charging and discharging, resulting in lower reliability of a power storage device. However, the multilayer graphene 223 covering the periphery of the negative electrode active material 221 allows prevention of dispersion of the negative electrode active materials and the collapse of the negative electrode active material layer 203, even when the volume of silicon is increased and decreased due to charging and discharging.

When the surface of the negative electrode active material layer 203 is in contact with an electrolyte, the electrolyte and the negative electrode active material react with each other, so that a film is formed over a surface of the negative electrode. The film is called a solid electrolyte interface (SEI) and considered necessary to relieve the reaction of the electrode and the electrolyte for stabilization. However, when the thickness of the film is increased, carrier ions are less likely to be occluded in the negative electrode, leading to problems such as a reduction in conductivity of carrier ions between the electrode and the electrolyte, a decrease in discharge capacity due to the reduction in conductivity thereof, and a waste of the electrolyte.

Multilayer graphene coating the surface of the negative electrode active material layer 203 can suppress an increase in thickness of the film, so that a decrease in discharge capacity can be suppressed.

Next, a formation method of the negative electrode active material layer 203 in FIG. 2D will be described.

An uneven negative electrode active material is provided over a negative electrode current collector by a printing method, an ink jetmethod, a CVD method, or the like. Alternatively, a negative electrode active material having a film shape is formed by a coating method, a sputtering method, an evaporation method, or the like, and then is selectively removed, so that the uneven negative electrode active material is provided over a negative electrode current collector. Still alternatively, a surface of foil or a plate which is formed of lithium, aluminum, graphite, or silicon is partly removed to form a negative electrode current collector and a negative electrode active material that have an uneven shape. Further alternatively, a net formed of lithium, aluminum, graphite, or silicon may be used for the negative electrode active material and the negative electrode current collector.

After that, the mixed solution containing graphene oxide is applied to the negative electrode active material as in Embodiment 1. As a method of applying the mixed solution containing graphene oxide to the negative electrode active material, a coating method, a spin coating method, a dipping method, a spray method, an electrophoresis method, or the like may be employed. Then, heating is performed in a reducing atmosphere for reduction treatment so that part of oxygen is released from the graphene oxide provided over the negative electrode active material to form openings in graphene, as in the formation method of multilayer graphene, which is described in Embodiment 1. Note that oxygen in the graphene oxide is not entirely reduced and partly remains in the graphene. Through the above process, the negative electrode active material layer 203 in which a surface of the negative electrode active material 221 is coated with the multilayer graphene 223 can be formed.

The use of the mixed solution containing graphene oxide in formation of multilayer graphene permits a surface of the uneven negative electrode active material to be coated with multilayer graphene having an even thickness.

Note that the uneven negative electrode active material (hereinafter referred to as silicon whiskers) formed of silicon can be provided over the negative electrode current collector by an LPCVD method using silane, silane chrolide, silane fluoride, or the like as a source gas. In the case of silicon which is an example of a negative electrode active material, the volume is approximately quadrupled due to occlusion of ions serving as carriers; therefore, the negative electrode active material layer gets vulnerable and is partly collapsed by charging and discharging, resulting in lower reliability of a power storage device. However, the multilayer graphene covering a surface of the silicon whiskers allows suppression of the collapse of the negative electrode active material layer due to expansion of the volume of the silicon whiskers; consequently, reliability and durability of a power storage device can be increased.

Next, a positive electrode and a formation method thereof will be described.

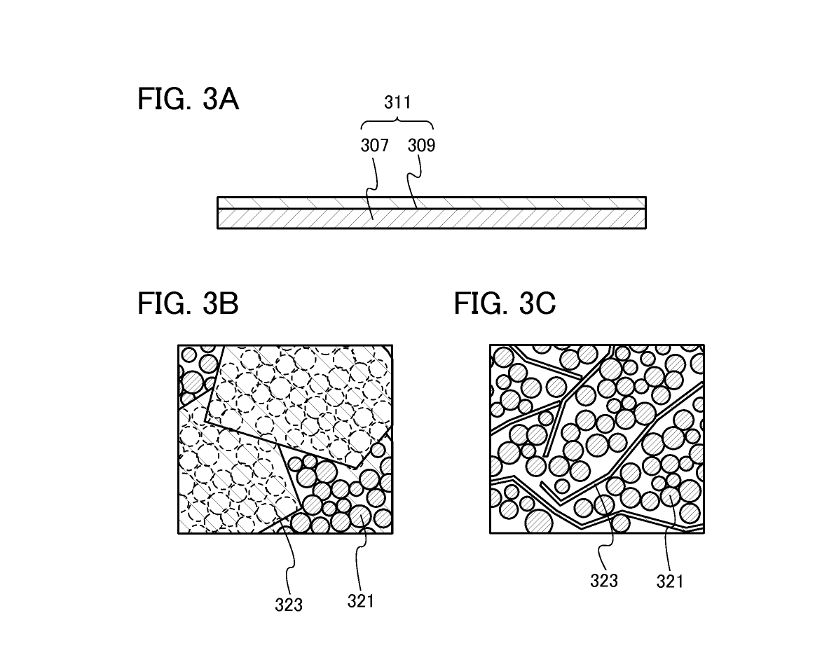

FIG. 3A is a cross-sectional view of a positive electrode 311. In the positive electrode 311, a positive electrode active material layer 309 is formed over a positive electrode current collector 307.

As the positive electrode current collector 307, a material having high conductivity such as platinum, aluminum, copper, titanium, or stainless steel can be used. The positive electrode current collector 307 can have a foil shape, a plate shape, a net shape, or the like as appropriate.

The positive electrode active material layer 309 can be formed using a lithium compound such as LiFeO₂, LiCoO₂, LiNiO₂, or LiMn₂O₄, or V₂O₅, Cr₂O₅, or MnO₂ as a material.

Alternatively, an olivine-type lithium-containing composite oxide (a general formula LiMPO₄ (M is one or more of Fe, Mn, Co, and Ni)) may be used. Typical examples of the general formula LiMPO₄ which can be used as a material are lithium compounds such as LiFePO₄, LiNiPO₄, LiCoPO₄, LiMnPO₄, LiFeₐNi_{b}PO₄, LiFeₐCo_{b}PO₄, LiFeₐMn_{b}PO₄, LiNiₐCo_{b}PO₄, LiNiₐMn_{b}PO₄ (a+b≦1, 0<a<1, and 0<b<1), LiFe_{c}Ni_{d}CoₑPO₄, LiFe_{c}Ni_{d}MnₑPO₄, LiNi_{c}Co_{d}MnₑPO₄ (c+d+e≦1, 0<c<1, 0<d<1, and 0<e<1), and LiFe_{f}Ni_{g}CoₕMnᵢPO₄ (f+g+h+i≦1, 0<f<1, 0<g<1, 0<h<1, and 0<i<1).

Alternatively, a lithium-containing composite oxide such as a general formula Li₂MSiO₄ (M is one or more of Fe, Mn, Co, and Ni) may be used. Typical examples of the general formula Li₂MSiO₄ which can be used as a material are lithium compounds such as Li₂FeSiO₄, Li₂NiSiO₄, Li₂CoSiO₄, Li₂MnSiO₄, Li₂FeₖNiₙSiO₄, Li₂FeₖCoᵢSiO₄, Li₂FeₖMnᵢSiO₄, Li₂NiₖCoᵢSiO₄, Li₂NiₖMnᵢSiO₄ (k+l≦1, 0<k<1, and 0<l<1), Li₂FeₘNiₙCo_{q}SiO₄, Li₂FeₘNiₙMn_{q}SiO₄, Li₂Niₘ,CoₙMn_{q}SiO₄ (m+n+q<1, 0<m<1, 0<n<1, and 0<q<1), and Li₂FeᵣNiₛCoₜMnᵤSiO₄ (r+s+t+u≦1, 0<r<1, 0<s<1, 0<t<1, and 0<u<1).

In the case where carrier ions are alkali metal ions other than lithium ions, alkaline-earth metal ions, beryllium ions, or magnesium ions, the positive electrode active material layer 309 may contain, instead of lithium in the lithium compound and the lithium-containing composite oxide, an alkali metal (e.g., sodium or potassium), an alkaline-earth metal (e.g., calcium, strontium, or barium), beryllium, or magnesium.

FIG. 3B is a plan view of the positive electrode active material layer 309. The positive electrode active material layer 309 contains positive electrode active materials 321 which are particles capable of occluding and releasing carrier ions, and multilayer graphenes 323 which cover a plurality of particles of the positive electrode active materials 321 and at least partly surround the plurality of particles of the positive electrode active materials 321. The different multilayer graphenes 323 cover surfaces of the plurality of particles of the positive electrode active materials 321. The positive electrode active materials 321 may partly be exposed.

The size of the particle of the positive electrode active material 321 is preferably 20 nm to 100 nm inclusive. Note that the size of the particle of the positive electrode active material 321 is preferably smaller because electrons transfer in the positive electrode active materials 321.

In the case where the positive electrode active material layer 309 contains the multilayer graphenes 323, sufficient characteristics can be obtained even when surfaces of the positive electrode active materials 321 are not coated with a carbon film; however, it is preferable to use both the multilayer graphene 323 and the positive electrode active material coated with a carbon film because electrons transfer hopping between the positive electrode active materials.

FIG. 3C is a cross-sectional view of part of the positive electrode active material layer 309 in FIG. 3B. The positive electrode active material layer 309 contains the positive electrode active materials 321 and the multilayer graphenes 323 which cover the positive electrode materials 321. The multilayer graphenes 323 are observed to have linear shapes in cross section. A plurality of particles of the positive electrode active materials are at least partly surrounded with one multilayer graphene or plural multilayer graphenes. Note that the multilayer graphene has a bag-like shape, and the plurality particles of the positive electrode active materials are at least partly surrounded with the bag-like portion in some cases. The multilayer graphene partly has openings where the positive electrode active materials are exposed in some cases.

The desired thickness of the positive electrode active material layer 309 is determined in the range of 20 μm to 100 μm. It is preferable to adjust the thickness of the positive electrode active material layer 309 as appropriate so that a crack and separation are not caused.

Note that the positive electrode active material layer 309 may contain acetylene black particles having a volume 0.1 to 10 times as large as that of the multilayer graphene, carbon particles having a one-dimensional expansion (e.g., carbon nanofibers), or other known binders.

As an example of the positive electrode active material, a material whose volume is expanded by occlusion of ions serving as carriers is given. When such a material is used, the positive electrode active material layer gets vulnerable and is partly collapsed by charging and discharging, resulting in lower reliability of a power storage device. However, the multilayer graphene 323 covering the periphery of the positive electrode active materials allows prevention of dispersion of the positive electrode active materials and the collapse of the positive electrode active material layer, even when the volume of the positive electrode active materials is increased and decreased due to charging and discharging. That is to say, the multilayer graphene has a function of maintaining the bond between the positive electrode active materials even when the volume of the positive electrode active materials is increased and decreased by charging and discharging.

The multilayer graphene 323 is in contact with a plurality of particles of the positive electrode active materials and serves also as a conductive additive. Further, the multilayer graphene 323 has a function of holding the positive electrode active materials 321 capable of occluding and releasing carrier ions. Thus, binder does not necessarily have to be mixed into the positive electrode active material layer. Accordingly, the proportion of the positive electrode active materials in the positive electrode active material layer can be increased and the discharge capacity of a power storage device can be increased.

Next, a formation method of the positive electrode active material layer 309 will be described.

Slurry containing positive electrode active materials which are particles and graphene oxide is formed. After a positive electrode current collector is coated with the slurry, heating is performed in a reducing atmosphere for reduction treatment so that the positive electrode active materials are baked and part of oxygen is released from graphene oxide to form openings in graphene, as in the formation method of multilayer graphene, which is described in Embodiment 1. Note that oxygen in graphene oxide is not entirely reduced and partly remains in graphene. Through the above process, the positive electrode active material layer 309 can be formed over the positive electrode current collector 307. Consequently, the positive electrode active material layer 309 has higher conductivity.

Graphene oxide contains oxygen and thus is negatively charged in a polar liquid. As a result of being negatively charged, graphene oxide is dispersed. Accordingly, the positive electrode active materials contained in the slurry are not easily aggregated, so that the size of the particle of the positive electrode active material can be prevented from increasing. Thus, the transfer of electrons in the positive electrode active materials is facilitated, resulting in an increase in conductivity of the positive electrode active material layer.

### Embodiment 3

In this embodiment, a method for manufacturing a power storage device will be described.

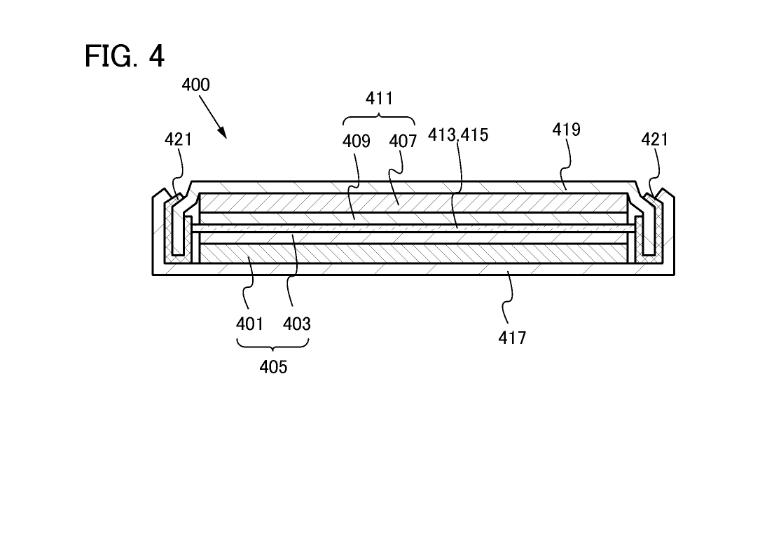

A lithium-ion secondary battery in this embodiment which is a typical example of power storage devices will be described with reference to FIG. 4. Here, description will be given below of a cross-sectional structure of the lithium-ion secondary battery.

FIG. 4 is a cross-sectional view of the lithium ion secondary battery.

A lithium-ion secondary battery 400 includes a negative electrode 411 including a negative electrode current collector 407 and a negative electrode active material layer 409, a positive electrode 405 including a positive electrode current collector 401 and a positive electrode active material layer 403, and a separator 413 provided between the negative electrode 411 and the positive electrode 405. Note that the separator 413 is impregnated with an electrolyte 415. The negative electrode current collector 407 is connected to an external terminal 419 and the positive electrode current collector 401 is connected to an external terminal 417. An end portion of the external terminal 419 is embedded in a gasket 421. That is to say, the external terminals 417 and 419 are insulated from each other by the gasket 421.

As the negative electrode current collector 407 and the negative electrode active material layer 409, the negative electrode current collector 201 and the negative electrode active material layer 203 which are described in Embodiment 2 can be used as appropriate.

As the positive electrode current collector 401 and the positive electrode active material layer 403, the positive electrode current collector 307 and the positive electrode active material layer 309 which are described in Embodiment 2 can be used as appropriate.

As the separator 413, an insulating porous material is used. Typical examples of the separator 413 include cellulose (paper), polyethylene, polypropylene, and the like.

As a solute of the electrolyte 415, a material in which carrier ions can transfer and exist stably is used. Typical examples of the solute of the electrolyte include lithium salts such as LiClO₄, LiAsF₆, LiBF₄, LiPF₆, and Li(C₂F₅SO₂)₂N.

Note that when carrier ions are alkali metal ions other than lithium ions, alkaline-earth metal ions, beryllium ions, or magnesium ions, instead of lithium in the above lithium salts, an alkali metal (e.g., sodium or potassium), an alkaline-earth metal (e.g., calcium, strontium, or barium), beryllium, or magnesium may be used for a solute of the electrolyte 415.

As a solvent of the electrolyte 415, a material in which lithium ions can transfer is used. As the solvent of the electrolyte 415, an aprotic organic solvent is preferably used. Typical examples of aprotic organic solvents include ethylene carbonate, propylene carbonate, dimethyl carbonate, diethyl carbonate, γ-butyrolactone, acetonitrile, dimethoxyethane, tetrahydrofuran, and the like, and one or more of these materials can be used. When a gelled high-molecular material is used as the solvent of the electrolyte 415, safety against liquid leakage and the like is improved. Further, the lithium-ion secondary battery 400 can be thinner and more lightweight. Typical examples of gelled high-molecular materials include a silicon gel, an acrylic gel, an acrylonitrile gel, polyethylene oxide, polypropylene oxide, a fluorine-based polymer, and the like.

As the electrolyte 415, a solid electrolyte such as Li₃PO₄ can be used. Note that in the case of using such a solid electrolyte as the electrolyte 415, the separator 413 is unnecessary.

For the external terminals 417 and 419, a metal material such as a stainless steel plate or an aluminum plate can be used as appropriate.

Note that in this embodiment, a coin-type lithium-ion secondary battery is given as the lithium-ion secondary battery 400; however, any of lithium-ion secondary batteries with various shapes, such as a sealing-type lithium-ion secondary battery, a cylindrical lithium-ion secondary battery, and a square-type lithium-ion secondary battery, can be used. Further, a structure in which a plurality of positive electrodes, a plurality of negative electrodes, and a plurality of separators are stacked or rolled may be employed.

A lithium-ion secondary battery according to this embodiment has a high energy density, a large capacity, and a high output voltage, which enables reduction in size and weight. Therefore, cost can be reduced. Further, the lithium-ion secondary battery does not easily deteriorate due to repetitive charge and discharge and can be used for a long time.

Next, a method for manufacturing the lithium-ion secondary battery 400 according to this embodiment will be described.

By the manufacturing method described in Embodiment 2, the positive electrode 405 and the negative electrode 411 are formed.

Next, the positive electrode 405, the separator 413, and the negative electrode 411, are impregnated with the electrolyte 415. Then, the positive electrode 405, the separator 413, the gasket 421, the negative electrode 411, and the external terminal 419 are stacked in this order over the external terminal 417, and the external terminal 417 and the external terminal 419 are crimped to each other with a “coin cell crimper”. Thus, the coin-type lithium-ion secondary battery can be manufactured.

Note that a spacer and a washer may be provided between the external terminal 417 and the positive electrode 405 or between the external terminal 419 and the negative electrode 411 so that the connection between the external terminal 417 and the positive electrode 405 or between the external terminal 419 and the negative electrode 411 is enhanced.

### Embodiment 4

The power storage device according to one embodiment of the present invention can be used for power supplies of a variety of electric appliances which can be operated with power.

Specific examples of electric appliances each utilizing the power storage device according to one embodiment of the present invention are as follows: display devices, lighting devices, desktop personal computers and laptop personal computers, image reproduction devices which reproduce still images and moving images stored in recording media such as digital versatile discs (DVDs), mobile phones, portable game machines, portable information terminals, e-book readers, video cameras, digital still cameras, high-frequency heating appliances such as microwave ovens, electric rice cookers, electric washing machines, air-conditioning systems such as air conditioners, electric refrigerators, electric freezers, electric refrigerator-freezers, freezers for preserving DNA, and dialyzers. In addition, moving objects driven by electric motors using power from power storage devices are also included in the category of electric appliances. Examples of the moving objects include electric vehicles, hybrid vehicles each including both an internal-combustion engine and an electric motor, and motorized bicycles including motor-assisted bicycles.

In the electric appliances, the power storage device according to one embodiment of the present invention can be used as a power storage device for supplying enough power for almost the whole power consumption (referred to as a main power supply). Alternatively, in the electric appliances, the power storage device according to one embodiment of the present invention can be used as a power storage device which can supply power to the electric appliances when the supply of power from the main power supply or a commercial power supply is stopped (such a power storage device is referred to as an uninterruptible power supply). Still alternatively, in the electric appliances, the power storage device according to one embodiment of the present invention can be used as a power storage device for supplying power to the electric appliances at the same time as the power supply from the main power supply or a commercial power supply (such a power storage device is referred to as an auxiliary power supply).

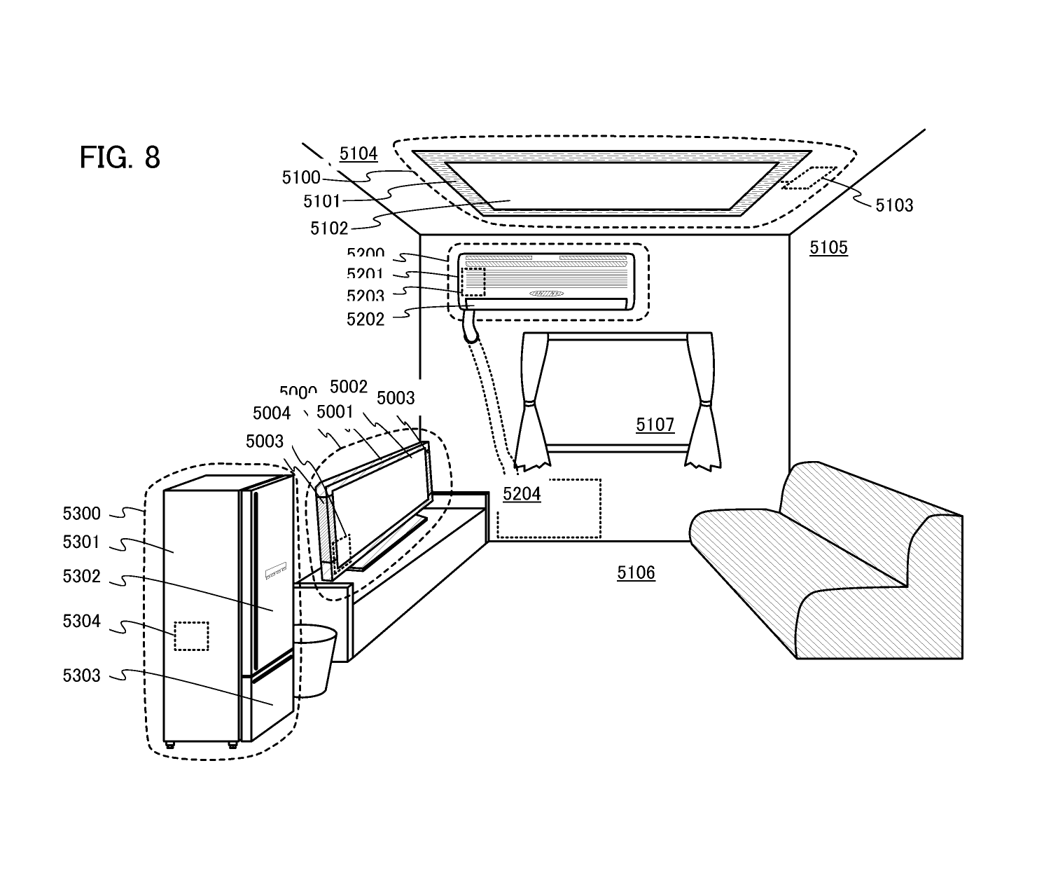

FIG. 8 illustrates specific structures of the electric appliances. In FIG. 8, a display device 5000 is an example of an electric appliance including a power storage device 5004 according to one embodiment of the present invention. Specifically, the display device 5000 corresponds to a display device for TV broadcast reception and includes a housing 5001, a display portion 5002, speaker portions 5003, and the power storage device 5004. The power storage device 5004 according to one embodiment of the present invention is provided in the housing 5001. The display device 5000 can receive power from a commercial power supply. Alternatively, the display device 5000 can use power stored in the power storage device 5004. Thus, the display device 5000 can be operated with the use of the power storage device 5004 according to one embodiment of the present invention as an uninterruptible power supply even when power cannot be supplied from a commercial power supply due to power failure or the like.

A semiconductor display device such as a liquid crystal display device, a light-emitting device in which a light-emitting element such as an organic EL element is provided in each pixel, an electrophoresis display device, a digital micromirror device (DMD), a plasma display panel (PDP), or a field emission display (FED) can be used for the display portion 5002.

Note that the display device includes, in its category, all of information display devices for personal computers, advertisement displays, and the like besides TV broadcast reception.

In FIG. 8, an installation lighting device 5100 is an example of an electric appliance including a power storage device 5103 according to one embodiment of the present invention. Specifically, the lighting device 5100 includes a housing 5101, a light source 5102, and a power storage device 5103. Although FIG. 8 illustrates the case where the power storage device 5103 is provided in a ceiling 5104 on which the housing 5101 and the light source 5102 are installed, the power storage device 5103 may be provided in the housing 5101. The lighting device 5100 can receive power from a commercial power supply. Alternatively, the lighting device 5100 can use power stored in the power storage device 5103. Thus, the lighting device 5100 can be operated with the use of the power storage device 5103 according to one embodiment of the present invention as an uninterruptible power supply even when power cannot be supplied from a commercial power supply due to power failure or the like.

Note that although the installation lighting device 5100 provided in the ceiling 5104 is illustrated in FIG. 8 as an example, the power storage device according to one embodiment of the present invention can be used in an installation lighting device provided in, for example, a wall 5105, a floor 5106, a window 5107, or the like other than the ceiling 5104. Alternatively, the power storage device can be used in a tabletop lighting device or the like.

As the light source 5102, an artificial light source which emits light artificially by using power can be used. Specifically, discharge lamps such as an incandescent lamp and a fluorescent lamp, and light-emitting elements such as an LED and an organic EL element are given as examples of the artificial light source.

In FIG. 8, an air conditioner including an indoor unit 5200 and an outdoor unit 5204 is an example of an electric appliance including a power storage device 5203 according to one embodiment of the invention. Specifically, the indoor unit 5200 includes a housing 5201, an air outlet 5202, and a power storage device 5203. Although FIG. 8 illustrates the case where the power storage device 5203 is provided in the indoor unit 5200, the power storage device 5203 may be provided in the outdoor unit 5204. Alternatively, the power storage devices 5203 may be provided in both the indoor unit 5200 and the outdoor unit 5204. The air conditioner can receive power from a commercial power supply. Alternatively, the air conditioner can use power stored in the power storage device 5203. Particularly in the case where the power storage devices 5203 are provided in both the indoor unit 5200 and the outdoor unit 5204, the air conditioner can be operated with the use of the power storage device 5203 according to one embodiment of the present invention as an uninterruptible power supply even when power cannot be supplied from a commercial power supply due to power failure or the like.

Note that although the split-type air conditioner including the indoor unit and the outdoor unit is illustrated in FIG. 8 as an example, the power storage device according to one embodiment of the present invention can be used in an air conditioner in which the functions of an indoor unit and an outdoor unit are integrated in one housing.

In FIG. 8, an electric refrigerator-freezer 5300 is an example of an electric appliance including a power storage device 5304 according to one embodiment of the present invention. Specifically, the electric refrigerator-freezer 5300 includes a housing 5301, a door for a refrigerator 5302, a door for a freezer 5303, and the power storage device 5304. The power storage device 5304 is provided in the housing 5301 in FIG. 8. The electric refrigerator-freezer 5300 can receive power from a commercial power supply. Alternatively, the electric refrigerator-freezer 5300 can use power stored in the power storage device 5304. Thus, the electric refrigerator-freezer 5300 can be operated with the use of the power storage device 5304 according to one embodiment of the present invention as an uninterruptible power supply even when power cannot be supplied from a commercial power supply due to power failure or the like.

Note that among the electric appliances described above, a high-frequency heating apparatus such as a microwave oven and an electric appliance such as an electric rice cooker require high power in a short time. The tripping of a breaker of a commercial power supply in use of an electric appliance can be prevented by using the power storage device according to one embodiment of the present invention as an auxiliary power supply for supplying power which cannot be supplied enough by a commercial power supply.

In addition, in a time period when electric appliances are not used, particularly when the proportion of the amount of power which is actually used to the total amount of power which can be supplied from a commercial power supply source (such a proportion referred to as a usage rate of power) is low, power can be stored in the power storage device, whereby the usage rate of power can be reduced in a time period when the electric appliances are used. For example, in the case of the electric refrigerator-freezer 5300, power can be stored in the power storage device 5304 in night time when the temperature is low and the door for a refrigerator 5302 and the door for a freezer 5303 are not often opened or closed. On the other hand, in daytime when the temperature is high and the door for a refrigerator 5302 and the door for a freezer 5303 are frequently opened and closed, the power storage device 5304 is used as an auxiliary power supply; thus, the usage rate of power in daytime can be reduced.

This embodiment can be implemented in appropriate combination with any of the above embodiments.

### Example 1

In this example, multilayer graphene was formed over silicon whiskers, an example of a negative electrode active material, and was observed by scanning electron microscopy (SEM) and transmission electron microscopy (TEM). First, a formation method of a sample will be described.

At the beginning, a mixed solution containing 0.5 mg/ml of graphene oxide was prepared. Further, a silicon active material layer was formed over a titanium sheet.

A formation method of the silicon active material layer will be described below. Silicon whiskers were formed as the silicon active material layer over a titanium sheet with a thickness of 0.1 mm and a diameter of 12 mm by an LPCVD method in which silane was introduced as a source gas at a flow rate of 700 sccm into a chamber where the pressure was 100 Pa and the temperature was 600° C.

After that, the silicon active material layer was soaked in the mixed solution containing the graphene oxide for about 10 seconds and then lifted over about five seconds. Next, the mixed solution containing the graphene oxide was dried with a hot plate at 50° C. for a few minutes and then left for 10 hours in a chamber maintained at 600° C. in a vacuum so that the graphene oxide was subjected to reduction treatment. Thus, multilayer graphene was formed.

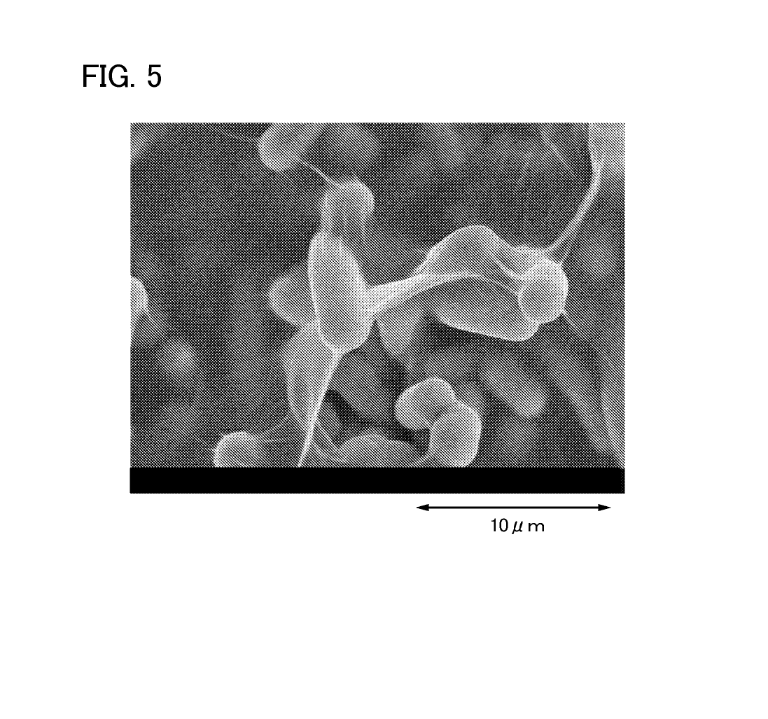

FIG. 5 is a top plan SEM image of the sample (magnification: 5000 times). Here, a central portion of the sample was observed. In FIG. 5, the multilayer graphene is provided over a surface so as to cover the silicon whiskers.

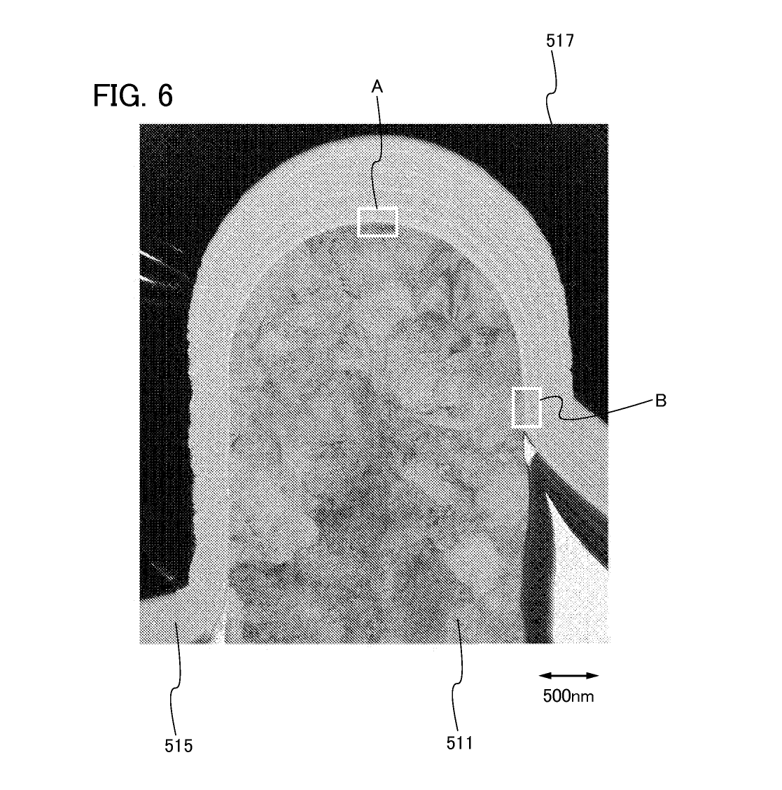

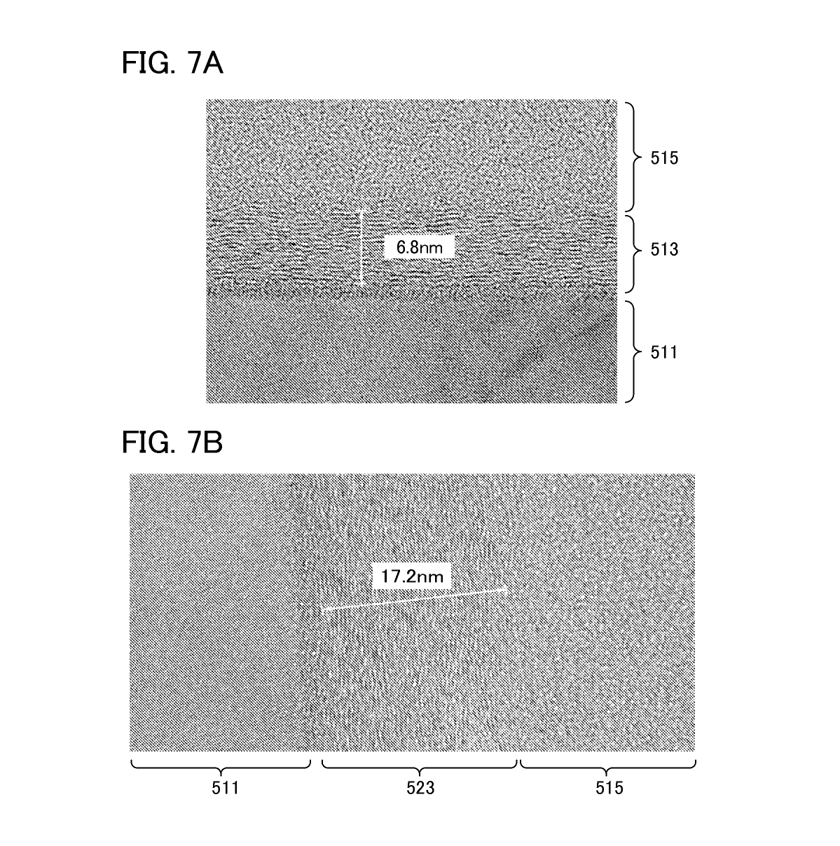

FIG. 6 is a cross-sectional TEM image showing the sample in FIG. 5 sliced with a focused ion beam (FIB) (magnification: 48000 times). A carbon film 515 which facilitates observation and a tungsten film 517 are provided over a surface of a silicon whisker 511. FIG. 7A is an enlarged view of a region A, which is the top portion of the silicon whisker in FIG. 6 (magnification: 2050000 times), and FIG. 7B is an enlarged view of a region B, which is a side surface of the silicon whisker in FIG. 6 (magnification: 2050000 times). In FIG. 7A, multilayer graphene 513 is provided over the surface of the silicon whisker 511, and in FIG. 7B, multilayer graphene 523 is provided over the surface of the silicon whisker 511. Further, the carbon film 515, which facilitates observation, is provided over surfaces of the multilayer graphenes 513 and 523.

In FIG. 7A, a low-visibility (white) linear layer is stacked in parallel with a surface of the silicon active material layer. The linear layer corresponds to a highly crystalline graphene region. The length of the region is 1 nm to 10 nm inclusive, preferably 1 nm to 2 nm inclusive. Since the diameter of a six-membered ring composed of carbon atoms is 0.246 nm, highly crystalline graphene contains five or more and eight or less six-membered rings. The low-visibility linear layer is partly discontinuous and a slightly high-visibility (gray) region is provided between low-visibility (white) layers. The slightly high-visibility region corresponds to an opening serving as a path through which ions can transfer. Further, it is found that the thickness of the multilayer graphene is about 6.8 nm and the interlayer distance between graphenes is about 0.35 nm to 0.5 nm. When the interlayer distance of the multilayer graphene is 0.4 nm, the number of graphene layers is presumably about 17.

In FIG. 7B, a low-visibility (white) linear layer is stacked in parallel with the surface of the silicon active material layer as in FIG. 7A. The low-visibility linear layer is partly discontinuous and a slightly high-visibility (gray) region is provided between low-visibility layers. The thickness of the multilayer graphene is about 17.2 nm. When the interlayer distance of the multilayer graphene is 0.4 nm, the number of graphene layers is presumably about 43.

In this example, the multilayer graphene in which graphenes are stacked in parallel with the surface of the base was formed.

### Example 2

In this example, the oxygen concentration in multilayer graphene was measured. First, a formation method of a sample will be described.

At the beginning, 5 g of graphite and 126 ml of concentrated sulfuric acid were mixed to give a mixed solution 1. Then, 12 g of potassium permanganate was added to the mixed solution 1 while they are stirred in an ice bath, so that a mixed solution 2 was formed. After the ice bath was removed and stirring was performed for two hours at room temperature, the resulting solution was left at 35° C. for 30 minutes so that oxidation reaction was caused; consequently, a mixed solution 3 containing graphite oxide was formed. Then, 184 ml of water was added to the mixed solution 3 while they were stirred in an ice bath, so that a mixed solution 4 was formed. After the mixed solution 4 was stirred in an oil bath at about 95° C. for 15 minutes so that reaction was caused, 560 ml of water and 36 ml of hydrogen peroxide solution (with a concentration of 30 wt %) were added to the mixed solution 4 while they were stirred, in order to reduce unreacted potassium permanganate; thus, a mixed solution 5 containing graphite oxide was formed.

After suction filtration of the mixed solution 5 was conducted using a membrane filter with a pore size of 1 μm, hydrochloric acid was mixed into the resulting solution and sulfuric acid was removed from the resulting solution, so that a mixed solution 6 containing graphite oxide was formed.

Water was added to the mixed solution 6, and centrifugation was carried out at 3000 rpm for about 30 minutes to remove a supernatant fluid containing hydrochloric acid. Then, a process in which water was added to a precipitate and centrifugation was carried out to remove a supernatant fluid was repeated a plurality of times so that hydrochloric acid was removed. When the pH of the mixed solution 6 from which the supernatant fluid was removed reached about 5 to 6, ultrasonic treatment was performed on the precipitate for two hours to separate graphene oxide from graphite oxide. Consequently, a mixed solution 7 in which graphene oxide is dispersed was formed.

Water in the mixed solution 7 was removed with an evaporator, and a residue was ground in a mortar and heated in a glass tube oven at 300° C. in a vacuum for 10 hours so that oxygen in the graphene oxide was reduced to be partly released. Thus, multilayer graphene was obtained. Table 1 shows XPS analysis results of the composition of the obtained multilayer graphene. Here, measurements were performed using Quantera SXM manufactured by ULVAC-PHI, Inc. Note that the determination precision was about ±1 atomic %.

TABLE 1
(atomic %)

| Li | Fe | P | O | C | S | N |
|---|---|---|---|---|---|---|
| — | — | — | 11.3 | 88.7 | — | — |

Table 1 reveals that the multilayer graphene contains oxygen. Note that the concentrations of elements in the outermost surface of the sample were measured.

Therefore, the measured value of oxygen possibly includes the concentration of oxygen which oxidizes the surface of the multilayer graphene in the air, i.e., the oxygen concentration in the multilayer graphene is possibly lower than that shown in Table 1.

This application is based on Japanese Patent Application serial no. 2011-141036 filed with the Japan Patent Office on Jun. 24, 2011, the entire contents of which are hereby incorporated by reference.

What is claimed is:

1. Multilayer graphene comprising:
a plurality of graphenes stacked in a layered manner,
wherein the plurality of graphenes comprise:
a six-membered ring composed of carbon atoms;
a poly-membered ring which is a seven or more-membered ring composed of carbon atoms; and
an oxygen atom bonded to one of the carbon atoms in the six-membered ring and the poly-membered ring, and
wherein an interlayer distance between adjacent graphenes of the plurality of graphenes is greater than 0.34 nm and less than or equal to 0.5 nm.

2. The multilayer graphene according to claim 1,
wherein the interlayer distance between the graphenes is greater than or equal to 0.38 nm and less than or equal to 0.42 nm.

3. The multilayer graphene according to claim 1,
wherein the number of layers of the graphenes is 2 to 100.

4. Multilayer graphene comprising:
a plurality of graphenes stacked in a layered manner,
wherein the plurality of graphenes comprise:
a six-membered ring composed of carbon atoms; and
a poly-membered ring which is a seven or more-membered ring composed of carbon atoms and one or more oxygen atoms, and
wherein an interlayer distance between adjacent graphenes of the plurality of graphenes is greater than 0.34 nm and less than or equal to 0.5 nm.

5. The multilayer graphene according to claim 4,
wherein the interlayer distance between the graphenes is greater than or equal to 0.38 nm and less than or equal to 0.42 nm.

6. The multilayer graphene according to claim 4,
wherein an oxygen atom is bonded to one of the carbon atoms in the six-membered ring and the poly-membered ring.

7. The multilayer graphene according to claim 4,
wherein the number of layers of the graphenes is 2 to 100.

8. Multilayer graphene comprising:
carbon layers stacked in a layered manner,
wherein in the carbon layers, a plurality of six-membered rings each composed of carbon atoms and a plurality of poly-membered rings which are seven or more-membered rings each composed of carbon atoms are connected in a planar direction, and an oxygen atom is bonded to one of the carbon atoms in the six-membered ring and the poly-membered ring, and
wherein an interlayer distance between the carbon layers is greater than 0.34 nm and less than or equal to 0.5 nm.

9. The multilayer graphene according to claim 8,
wherein the interlayer distance between the carbon layers is greater than or equal to 0.38 nm and less than or equal to 0.42 nm.

10. The multilayer graphene according to claim 8,
wherein the number of the carbon layers is 2 to 100.

11. Multilayer graphene comprising:
carbon layers stacked in a layered manner,
wherein in the carbon layers, a plurality of six-membered rings each composed of carbon atoms and a plurality of poly-membered rings which are seven or more-membered rings each composed of carbon atoms and one or more oxygen atoms are connected in a planar direction, and
wherein an interlayer distance between the carbon layers is greater than 0.34 nm and less than or equal to 0.5 nm.

12. The multilayer graphene according to claim 11,
wherein the interlayer distance between the carbon layers is greater than or equal to 0.38 nm and less than or equal to 0.42 nm.

13. The multilayer graphene according to claim 11,
wherein an oxygen atom is bonded to one of the carbon atoms in the six-membered ring and the poly-membered ring.

14. The multilayer graphene according to claim 11,
wherein the number of the carbon layers is 2 to 100.

15. A power storage device comprising:
a positive electrode comprising a positive electrode active material layer; and
a negative electrode comprising a negative electrode active material layer,
wherein at least one of the positive electrode active material layer and the negative electrode active material layer comprises a plurality of active materials and multilayer graphene at least partly surrounding the plurality of active materials,
wherein in the multilayer graphene, a plurality of graphenes are stacked in a layered manner,
wherein the plurality of graphenes comprise:
a six-membered ring composed of carbon atoms;
a poly-membered ring which is a seven or more-membered ring composed of carbon atoms; and
an oxygen atom bonded to one of the carbon atoms in the six-membered ring and the poly-membered ring, and
wherein an interlayer distance between adjacent graphenes of the plurality of graphenes is greater than 0.34 nm and less than or equal to 0.5 nm.

16. The power storage device according to claim 15,
wherein the interlayer distance between the graphenes is greater than or equal to 0.38 nm and less than or equal to 0.42 nm.

17. The power storage device according to claim 15,
wherein the number of layers of the graphenes is 2 to 100.

18. A power storage device comprising:
a positive electrode comprising a positive electrode active material layer; and
a negative electrode comprising a negative electrode active material layer,
wherein at least one of the positive electrode active material layer and the negative electrode active material layer comprises a plurality of active materials and multilayer graphene at least partly surrounding the plurality of active materials,
wherein in the multilayer graphene, a plurality of graphenes are stacked in a layered manner,
wherein the plurality of graphenes comprise:
a six-membered ring composed of carbon atoms; and
a poly-membered ring which is a seven or more-membered ring composed of carbon atoms and one or more oxygen atoms, and
wherein an interlayer distance between adjacent graphenes of the plurality of graphenes is greater than 0.34 nm and less than or equal to 0.5 nm.

19. The power storage device according to claim 18,
wherein the interlayer distance between the graphenes is greater than or equal to 0.38 nm and less than or equal to 0.42 nm.

20. The power storage device according to claim 18,
wherein an oxygen atom is bonded to one of the carbon atoms in the six-membered ring and the poly-membered ring.

21. The power storage device according to claim 18,
wherein the number of layers of the graphenes is 2 to 100.

22. A power storage device comprising:
a positive electrode comprising a positive electrode active material layer; and
a negative electrode comprising a negative electrode active material layer,
wherein at least one of the positive electrode active material layer and the negative electrode active material layer comprises a plurality of active materials and multilayer graphene at least partly surrounding the plurality of active materials,
wherein in the multilayer graphene, carbon layers are stacked in a layered manner,
wherein in the carbon layers, a plurality of six-membered rings each composed of carbon atoms and a plurality of poly-membered rings which are seven or more-membered rings each composed of carbon atoms are connected in a planar direction, and an oxygen atom is bonded to one of the carbon atoms in the six-membered ring and the poly-membered ring, and
wherein an interlayer distance between the carbon layers is greater than 0.34 nm and less than or equal to 0.5 nm.

23. The power storage device according to claim 22,
wherein the interlayer distance between the carbon layers is greater than or equal to 0.38 nm and less than or equal to 0.42 nm.

24. The power storage device according to claim 22,
wherein the number of the carbon layers is 2 to 100.

25. A power storage device comprising:
a positive electrode comprising a positive electrode active material layer; and
a negative electrode comprising a negative electrode active material layer,
wherein at least one of the positive electrode active material layer and the negative electrode active material layer comprises a plurality of active materials and multilayer graphene at least partly surrounding the plurality of active materials,
wherein in the multilayer graphene, carbon layers are stacked in a layered manner,
wherein in the carbon layers, a plurality of six-membered rings each composed of carbon atoms and a plurality of poly-membered rings which are seven or more-membered rings each composed of carbon atoms and one or more oxygen atoms are connected in a planar direction, and
wherein an interlayer distance between the carbon layers is greater than 0.34 nm and less than or equal to 0.5 nm.

26. The power storage device according to claim 25,
wherein the interlayer distance between the carbon layers is greater than or equal to 0.38 nm and less than or equal to 0.42 nm.

27. The power storage device according to claim 25,
wherein an oxygen atom is bonded to one of the carbon atoms in the six-membered ring and the poly-membered ring.

28. The power storage device according to claim 25,
wherein the number of the carbon layers is 2 to 100.
